(19) United States
(12) Patent Application Publication
(10) Pub. No.: US 2010/0295361 A1
(43) Pub. Date: Nov. 25, 2010

(54) TEMPORARY SPLINT FOR BROKEN AXEL

(76) Inventor: Todd J. KENNEDY, Belleville, IL (US)

Correspondence Address: DON W. WEBER, 235 BRISTOL, TROY, IL, 62294, US

(21) Appl. No.: 12/469,859

(22) Filed: May 21, 2009

(51) Int. Cl. B60B 35/00

(52) U.S. Cl. 301/130

(57) ABSTRACT

An axel splint comprises five main parts that connect together. The axel splint is attached to the hitch of a vehicle to prevent a wheel from coming off when the axel is broken. The axel splint has a horizontal adjustable L-shaped hitch coupling piece 2 that is adjustably connected to an L-shaped adjustable extension bar 3. The extension bar 3 is adjustably connected to a circular cylinder rod 4 by a coupling piece 6. The cylinder rod 4 supports a rotatable tire cylinder 5 located at the wheel end of the cylinder rod. The tire cylinder 5 may be adjustably located along the length of the rod 4 by collars 14. The collars are fixed by two set screws and each collar has a bearing 16. The tire cylinder 5 rotates on the bearings and against the wheel of the broken axel, keeping the axel in the axel housing for emergency movement of the vehicle. The entire device (parts 2, 3, 4, 5 and 6) may be removably attached to the standard trailer hitch 7 when not in use using removable pins.

### BACKGROUND OF THE INVENTION

This invention relates to the field of vehicles and emergency movement of disabled vehicles. More particularly, a device is introduced that allows a vehicle with a broken axel in a remote location to be driven to safety.

In emergency situations where a driver has broken an axel in a remote location, the axel tends to come out of the axel housing and separate the axel and wheel from the vehicle when driven, making the vehicle inoperable. If the vehicle is an off-the-road vehicle it may be impractical or impossible for an emergency vehicle such as a tow truck to reach the remote location. In such circumstances, it may be necessary to hire a bulldozer or tractor to tow the vehicle. Such an operation is time consuming, cumbersome and often very expensive. It is an object of this invention to provide a safe, inexpensive device that may be used to extract a remote vehicle with a broken axel to a safer location.

If a device is capable of keeping the broken axel and hence the tire and wheel in its proper place, the disabled vehicle may be driven out of the remote location, thus saving much time and expense. At least one attempt has been made to create such a device. Off Road Trail Tools, LLC advertises a bar that may be attached to a disable vehicle by chains. The bar has two fixed tubes attached at fixed positions. The chains are attached to the vehicle so that the tubes rub along the sides of the tire to keep the broken axel and wheel in it proper place. While Off Road is an advance in this particular field, the device has certain drawbacks.

First as the tire rotates against the front fixed tube, the front tube tends to move downward. Conversely, the rear fixed tube tends to move upward, both in the counterclockwise rotational direction of the tire movement. This force tends to move the bar from the horizontal to an oblique angle. It is another object of this invention to provide an emergency device for a disabled vehicle that has a bar and cylinders that remain horizontal when in contact with a rotating tire.

Another problem with the Off Road device is that the tubes are fixed to the bar and remain stationary even when the tire rotates against the tubes. These fixed tubes create much wear on the sidewalls of the tire due to the friction created by the tubes rubbing on the tires. The heat and wear and tear generated by the fixed tubes require that the vehicle move very slowly, if at all. It is a further object of this invention to provide a device that keeps a broken axel and tire in place while providing a minimum of wear and friction to the sidewall of the tire.

A final problem with the Off Road device is that the fixed tubes are not always riding on the front and back part of the tire. Since the tubes are fixed, they must be placed in a generally advantageous location suitable to most vehicles. However, tire size and other factors vary markedly making a standard, fixed length a problem. It is a still further object of this invention to provide a tire restraining system that is adjustable to a wide variety of tire sizes and placements.

Other and further objects of this invention will become obvious upon reading the following specification and disclosure.

### BRIEF DESCRIPTION OF THE INVENTION

An axel splint to keep a broken axel and wheel from separating from the axel housing and vehicle is attached to the trailer hitch of the vehicle. The hitch coupling piece has an essentially square cross-section with an elongated L-shape. The short end of the coupling piece is inserted into the hitch. The long end of the coupling piece is horizontal to the ground and is inserted into the long end of an L-shaped extension bar. The coupling piece has adjustment holes for horizontal adjustment of the device. The short end of the extension bar is vertical and has adjustment holes. The extension bar is attached to a round rod which is horizontal to the ground and is located next to the rear tire of the broken axel. The rod is adjustably attached to the extension bar and the vertical height of the rod may be set as desired. A cylinder is adjustably attached around the rod by collars. The placement the cylinder may be set to any desired length along the rod. The cylinder is in contact with bearings and rotates freely about the rod. The horizontal adjustment of the extension bar and the vertical adjustment of the rod allow a user to set the cylinder against the wheel of the broken axel for emergency movement of the vehicle. The coupling piece and extension bar may be rotated 90 degrees to the vertical in the hitch when the device is not in use.

An alternative embodiment of the device has a rod attached to the vehicle by adjusting straps. Two cylinders are adjustably and rotatably attached to the rod. The straps hold the rod and tire cylinders against the wheel for emergency movement of the vehicle.

### BRIEF DESCRIPTION OF THE DRAWINGS

FIG. 1 is a perspective view of the preferred embodiment of the axel splint with the four-wheel drive vehicle shown in phantom lines.

FIG. 2 is a perspective view of the axel splint parts.

FIG. 3 is a perspective view of the wheel brace.

FIG. 4 is a partial end view of the axel splint shown in place on a wheel.

FIG. 5 is a cross-sectional view of the wheel brace and cylinders.

FIG. 6 is an end cross-sectional view of a normal wheel, axel and axel shaft.

FIG. 7 is an end cross-sectional view of a wheel, axel and axel shaft when the axel is broken.

FIG. 8 is an end cross-sectional view of a wheel, axel and axel shaft with the axel splint in place.

FIG. 9 is a perspective view of an alternate embodiment of the device in place with the four-wheel drive vehicle shown in phantom lines.

FIG. 10 is a perspective end view of the alternate embodiment shown in place on the four wheel drive vehicle.

### DETAILED DESCRIPTION OF THE PREFERRED EMBODIMENT

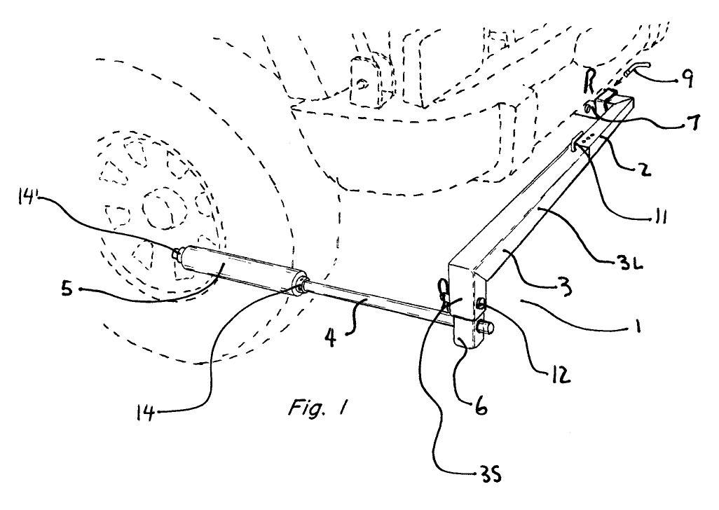

An axel splint 1, shown on FIG. 1, comprises five main parts that connect together to form the axel splint which may be attached to the hitch of a vehicle to prevent a wheel from coming off when the axel is broken. The axel splint has an adjustable L-shaped hitch coupling piece 2 which is adjustably connected to an L-shaped adjustable extension bar 3. The extension bar 3 is adjustably connected to a circular cylinder rod 4. The cylinder rod 4 supports a rotatable tire cylinder 5 located at the wheel end of the cylinder rod. The cylinder rod 4 has a cylinder rod adjusting and coupling piece 6 affixed to the other end. The entire device (parts 2, 3, 4, 5 and 6) may be removably attached to the standard trailer hitch 7 using removable pins.

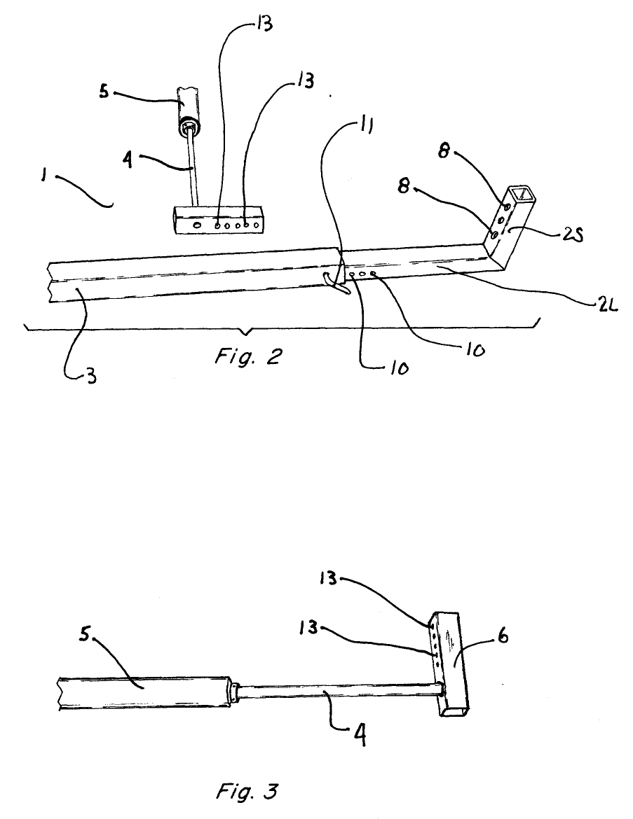

The hitch coupling piece has a square-shaped cross-section in the preferred embodiment to accommodate the standard square-shaped trailer hitch receiver 7. The hitch coupling piece has a short leg 2S and a long leg 2L, as best shown on FIG. 2. The short leg 2S has a plurality of hitch coupling adjusting holes 8 along one flat surface of the short leg. The long leg 2L has a plurality of long leg coupling adjusting holes 10 along a second flat surface at the extension end as shown. The short leg adjusting holes 8 allow a user to attach the hitch coupling at various distances from the hitch. The hitch coupling long leg extension holes 10 allow the user to attach the device at an appropriate horizontal distance from the hitch of the vehicle, as best shown in FIG. 1. The short leg is removably attached to the vehicle hitch in the standard and well known fashion by hitch coupling pin 9. The hitch coupling piece is adjustably and removably attached to the extension bar 3 by hitch coupling piece-extension bar pin 11.

Adjustably and removably attached to the hitch coupling piece 2 is an extension bar 3. The extension bar 3 is adapted to fit into the hitch coupling piece 2. The extension bar 3 has an essentially square cross-section and is L-shaped. The extension bar 3 has a bar long leg 3L and a bar short leg 3S shown in FIG. 1. A coupling hole is located at the hitch end of the long leg 3L and is adapted to receive the hitch coupling-extension bar pin 11 when one of the appropriate hitch coupling long leg extension holes 10 is aligned with the extension bar long leg hole. The short leg 3S of the extension bar is located at the tire end of the extension bar 3. This tire end has a hole adapted to receive the extension-cylinder rod adjusting piece pin 12.

The tire cylinder rod 4 has a tire cylinder rod adjusting and coupling piece 6 attached at one end, as best shown in FIGS. 2 and 3. This extension bar-cylinder coupling piece 6 has an essentially parallelepiped shape, as shown. The extension bar-cylinder coupling piece 6 has a plurality of adjusting holes 13 along one surface. The extension bar-cylinder adjusting holes 13 allow the user to adjust the vertical height of the tire rod 4 and of the axel splint 1. The cylinder rod adjusting and coupling piece 6 fits inside the extension bar 3 as best shown in FIG. 1. The height of the cylinder rod from the ground may be adjustably determined by the use of the adjusting holes 13. The cylinder coupling piece 6 is removably and adjustably attached to the extension bar 3 by extension-cylinder rod pin 12. Pins 9, 11, and 12 may be secured in place by cotter pins as shown.

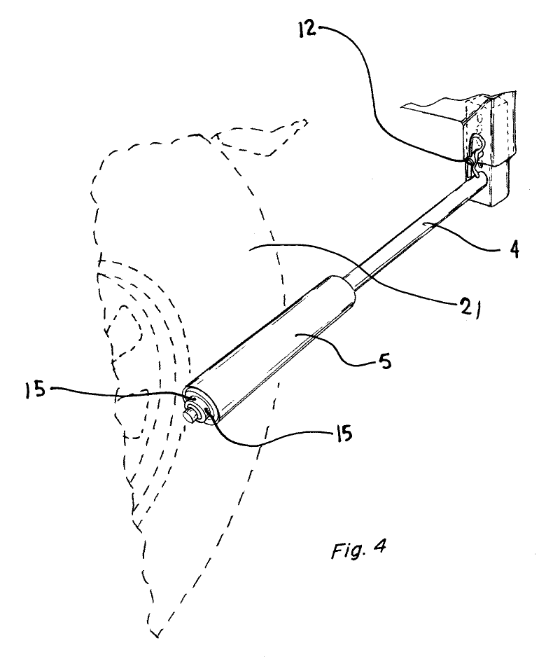

As best shown in FIGS. 1 and 4, the tire cylinder 5 is rotatably attached to the cylinder rod 4 by cylinder adjusting collars 14 and 14′. Each end of the cylinder 5 has a collar 14 and 14′ attached. These collars have set screws 15 as shown in FIG. 4. The set screws 15 are located approximately 60 degrees apart and allow the user to adjust the location of the cylinder 5 along the shaft of the cylinder rod 4. This adjustment is particularly important since it is desirable for the cylinder to ride on one side of the tire as best shown on FIG. 4.

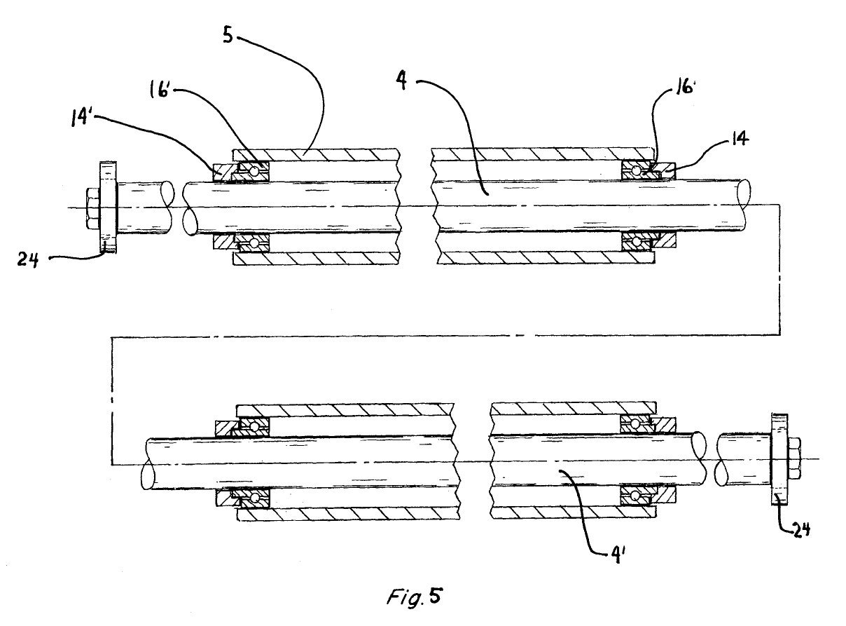

For each of the embodiments described herein, attached to each of the collars 14 and 14′ is a bearing 16 and 16′ respectively, as best shown on FIG. 5. The bearings 16 and 16′ allow the tire cylinder 5, which is in contact with the rotating tire 21, to turn freely about the rod 4. This is a great improvement over the prior art in that a freely turning tire cylinder 5 allows for better and more efficient operation of the device. FIG. 5 shows the structure of both embodiments with respect to the rod, collar and bearing.

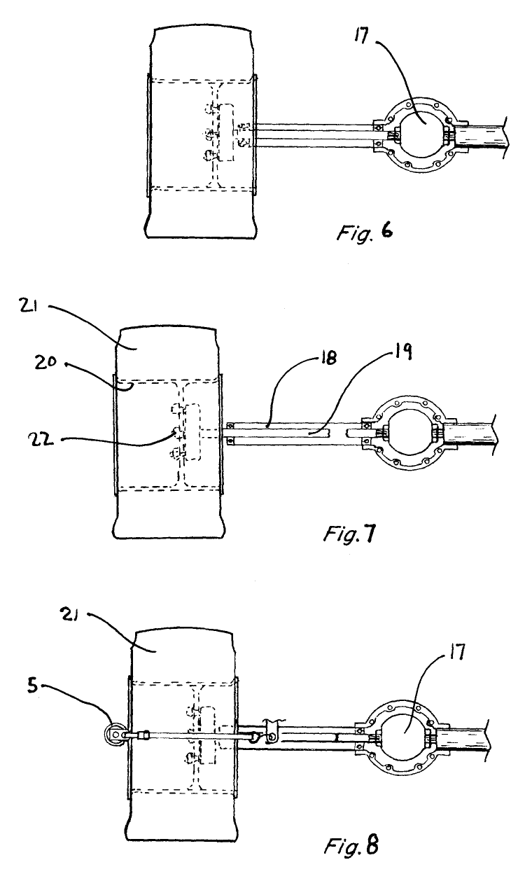

Turning now to FIGS. 6, 7 and 8, the operation of the device is shown. As shown in FIG. 6, in a normal condition the transmission 17 of a vehicle is rotatably connected to the axel 19 of a wheel. The axel 17 is located within the axel housing 18. The wheel rim 20 is attached to the end of the axel 17 by lug nuts 22 in a standard and well-known manner. The transmission turns the axel and drives the wheel rim 20 and hence the vehicle. However, as shown in FIG. 7, when an axel breaks it tends to work itself out of the axel housing 18. When axel 19 is far enough out of axel housing, the axel and wheel rim and tire will become separated from the vehicle with catastrophic consequences.

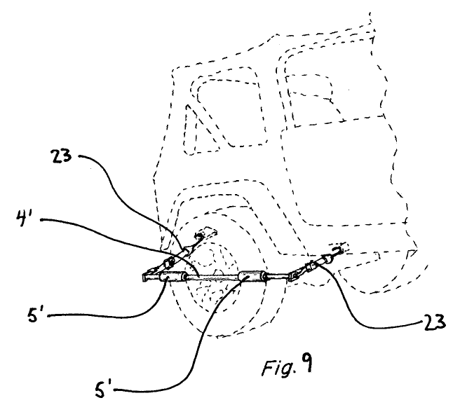

In order to prevent this catastrophic result from occurring, and in order to allow a user to drive his vehicle to safety or to a repair shop, the axel splint 1 is attached to the hitch as shown in FIG. 8. With one end of the axel splint attached to the hitch 7 and the other in contact with the tire 21, the tire cylinder 5 rolls along with the tire and the axel 19 is held within the axel housing.

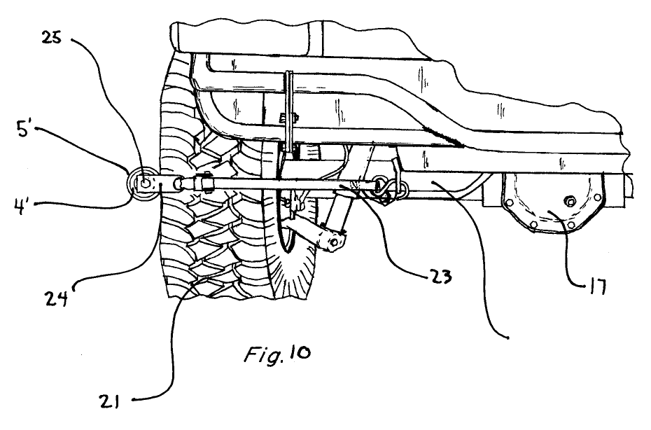

An alternative embodiment of the axel splint is shown in FIGS. 9 and 10. In this embodiment, the tire cylinder rod 4′ is attached to the vehicle with adjustable straps 23. The tire rod 4′, shown in FIG. 10, has an end piece 24 secured to each end of rod 4′ by a bolt 25. The end pieces have a hole adapted to receive one end of the securing strap. The other end of the securing strap is attached to the undercarriage of the vehicle as shown. The rod 4′ has two cylinders 5′ attached along the length of the rod. These cylinders have securing collars and bearings, as in the preferred embodiment. To deploy the alternate embodiment, the straps 23 are tightened against the vehicle and the rotatable cylinders 5 are secured against the side of the tire. Since the cylinders have bearings, the cylinders roll against both sides of the tire, as shown in FIG. 9.

This alternate embodiment offers several enhancements over the prior art. Since the cylinders are on bearings, they roll with the tire as it rotates. This action makes driving the crippled vehicle easier and saves wear on the tire sides. In addition, since the cylinders are adjustable along the length of the tire, the cylinders 5′ can be precisely located on each side of the tire. The prior art had neither the rotatable nor adjustable cylinders.

However, the alternate embodiment has several drawbacks from the preferred embodiment described above. The preferred embodiment not only has an adjustable and rotatable cylinder, it is also fixed in height since the hitch coupling, extension bar and cylinder rod are in a fixed location relative to the tire. On the “strap embodiment” the tire rod tends to move up as the tire rotates, especially when the cylinders are fixed to the rod and do not rotate. The preferred embodiment provides an axel splint that will not ride up as the tire rotates.

Another feature of the preferred embodiment is that it may be carried attached to the hitch, thus eliminating the need for extra storage space for the somewhat bulky axel splint. In order to carry the axel splint on the hitch when not in use, the short arm 2S of hitch coupling 2 is turned upward 90 degrees so that the long arm 2L of the hitch coupling is vertical from the hitch. The hitch coupling adjusting holes 8 allow for a user to adjust the length of the short arm 2S from the rear of the vehicle. Using this storage scheme, the long arm 3S of the extension bar is located on the long arm 2L of the hitch coupling. The only part of the axel splint that must be stored in the vehicle is the relatively small tire rod 4, tire cylinder 5 and coupling piece 6.

Having fully described my device, I claim:

1. An axel splint for a vehicle with a broken axel, comprising:
(a) an essentially L-shaped coupling piece having a short leg and a long leg, wherein said short leg is adapted to be received by a standard hitch;
(b) an essentially L-shaped extension bar having a long leg adjustably attached to the long leg of said coupling piece and a short leg;
(c) a tire cylinder rod having one end adjustably attached to said short leg of the extension bar;
(d) a tire cylinder rotatably and adjustably attached to said tire rod;
wherein said axel splint may be attached to a hitch of a vehicle and wherein said tire cylinder may be rotatably secured against a tire.

2. An axel splint for a vehicle with a broken axel as in claim 1, wherein the long leg of said L-shaped coupling piece has adjustment holes for adjusting the horizontal length of the axel splint from the hitch to the tire.

3. An axel splint for a vehicle with a broken axel as in claim 1, further comprising a cylinder rod adjusting and attaching piece having a plurality of adjusting holes, wherein the cylinder rod adjusting piece allows a user to adjust the vertical height of the axel splint.

4. An axel splint for a vehicle with a broken axel as in claim 1, wherein each end of said tire cylinder has an adjustable collar for securing said cylinder to said rod and wherein each end of said tire cylinder has a bearing to allow the cylinder to roll freely about said rod.

5. An axel splint for a vehicle with a broken axel as in claim 1, wherein the short leg of said coupling piece may be rotated upwardly 90 degrees to carry the coupling rod and extension bar on said hitch when not in use.

6. An axel splint for a vehicle with a wheel attached to a broken axel, comprising:
(a) a rod having an end piece at each end thereof;
(b) a pair of cylinders adjustably and rotatably attached around said rod;
(c) a pair of adjustable securing straps, each having one end attached to an end of said rod by said end pieces, and having the opposite end attached to said vehicle, whereby said cylinders may be tightened against the wheel of said broken axel such that the cylinders rotatably ride on said wheel.

7. An axel splint for a vehicle with a broken axel as in claim 6, wherein each end of each cylinder has an adjustable collar for securing said cylinder to said rod and wherein each end of said each cylinder has a bearing to allow the cylinders to roll freely about said rod.
